(19) United States
(12) Patent Application Publication
(10) Pub. No.: US 2018/0225976 A1
(43) Pub. Date: Aug. 9, 2018

(54) AUTOMATED REAL-TIME CLEARANCE ANALYSIS FOR AIR TRAFFIC

(71) Applicant: Architecture Technology Corporation, Minneapolis, MN (US)

(72) Inventors: David Rinehart, Charlottesville, VA (US); Noel E. Schmidt, Bloomington, MN (US); David Bartlett, La Plata, MD (US); Aditya Saraf, San Jose, CA (US); Paul Davis, San Jose, CA (US); Matthew A. Stillerman, Ithaca, NY (US)

(21) Appl. No.: 15/425,177

(22) Filed: Feb. 6, 2017

(51) Int. Cl. G08G 5/00; G06N 7/00

(52) U.S. Cl. CPC G08G 5/003; G08G 5/0082; G06N 7/005

(57) ABSTRACT

An example method includes receiving, by a computing device comprising one or more processors, from a plurality of sources, data associated with an aircraft that is in an operation, wherein the plurality of sources comprises one or more sources of historical data and one or more sources of real-time data that is generated while the aircraft is in the operation. The example method further includes performing, by the computing device, a risk analysis of the data using a Bayesian network model that models risks associated with the aircraft in the operation. The example method further includes generating, by the computing device, an output based at least in part on the risk analysis.

### STATEMENT REGARDING FEDERALLY SPONSORED RESEARCH OR DEVELOPMENT

This invention was made with Government support under Contract NNX16CA51P with NASA. The U.S. Government has certain rights in this invention.

### BACKGROUND

The primary guardians of aviation safety are conservative, heavily-tested designs, continuous human oversight, and consistent procedures and training. While these guardians are generally effective, accidents still occur, and furthermore these guardians place constraints on capacity, efficiency, the adoption of new procedures, the adoption of new technology, and support for new aircraft.

### SUMMARY

Systems, methods, devices, and techniques are described herein for an Automated Real-time Clearance Analyzer (ARCA). In various examples, an ARCA system of this disclosure may provide real-time analysis related to the clearance of an aircraft in flight in controlled airspace. In various examples, an ARCA system of this disclosure may perform a Bayesian network-based analysis in real-time, for an aircraft in flight, on relevant data from several sources to detect and respond to potential hazards. An ARCA system of this disclosure may help detect and prevent hazards in flight. In some examples, an ARCA system of this disclosure may replicate some aspects of hazard detection typically employed by skilled controllers or pilots or post-accident investigations, but employed automatically in the ARCA system during a flight in real-time.

In one example, a method includes receiving, by a computing device comprising one or more processors, from a plurality of sources, data associated with an aircraft that is in an operation, wherein the plurality of sources comprises one or more sources of historical data and one or more sources of real-time data that is generated while the aircraft is in the operation. The example method further includes performing, by the computing device, a risk analysis of the data using a Bayesian network model that models risks associated with the aircraft in the operation. The example method further includes generating, by the computing device, an output based at least in part on the risk analysis.

In another example, a computing device includes one or more processors and a computer-readable storage device communicatively coupled to the one or more processors. The computer-readable storage device stores instructions that, when executed by the one or more processors, cause the one or more processors to receive, from a plurality of sources, data associated with an aircraft that is in an operation, wherein the plurality of sources comprises one or more sources of historical data and one or more sources of real-time data that is generated while the aircraft is in the operation. The instructions further cause the one or more processors to perform a risk analysis of the data using a Bayesian network model that models risks associated with the aircraft in the operation. The instructions further cause the one or more processors to generate an output based at least in part on the risk analysis.

In another example, a computer-readable data storage device stores instructions that, when executed, cause a computing device comprising one or more processors to perform operations. The operations include receiving, from a plurality of sources, data associated with an aircraft that is in an operation, wherein the plurality of sources comprises one or more sources of historical data and one or more sources of real-time data that is generated while the aircraft is in the operation. The operations further include a risk analysis of the data using a Bayesian network model that models risks associated with the aircraft in the operation. The operations further include generating an output based at least in part on the risk analysis.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example Automated Real-time Clearance Analyzer (ARCA) system, in accordance with aspects of the present disclosure.

FIG. 2 is a conceptual diagram illustrating an example ARCA system that provides different outputs relative to different phases of flight of an aircraft, in accordance with aspects of the present disclosure.

FIG. 3 is a conceptual diagram illustrating an example implementation of an ARCA system comprising a Bayesian network (BN) model that the ARCA system may use to assess clearance for, e.g., approach and landing of an aircraft, in accordance with aspects of the present disclosure.

FIG. 4 is a conceptual diagram highlighting nodes in an example Bayesian network that may be updated midway through an operation, where the highlighted nodes represent newly available information or evidence that is pertinent to the risk analysis, in accordance with aspects of the present disclosure.

FIG. 5 is a flow diagram illustrating an example process that an ARCA system of any of FIGS. 1-4 may perform, in accordance with aspects of the present disclosure.

FIG. 6 is a block diagram illustrating an example computing device that may be used to host and/or execute an implementation of an ARCA system as described with reference to any of FIGS. 1-5, in accordance with aspects of the present disclosure.

FIGS. 7-9 depict another example of a Bayesian network model that an ARCA system may use to perform risk analysis associated with various available clearance options and/or to determine recommendations from among one or more available operations for a given clearance.

### DETAILED DESCRIPTION

An Automated Real-time Clearance Analyzer (ARCA) system of this disclosure may provide real-time software-based risk factor analysis for aircraft in operation. An ARCA system of this disclosure may provide an additional level of assurance by identifying and monitoring risks in real-time for an aircraft while it is in flight or otherwise being operated (e.g., planning, preparation, gate activities, taxiing) so that potential risks may be mitigated in real-time while the aircraft is being operated. An ARCA system of this disclosure may combine techniques such as probabilistic network modeling, e.g., using one or more Bayesian networks, and big data analytics, to provide a risk assessment of operational clearances (e.g., clearances for take-off and departure and clearances for approach and landing) in order to reduce or avoid operational risks. In some examples, an ARCA system of this disclosure has a function to focus on approach clearances, which may be referred to as ARCA-Approach or ARCA-A, and/or a function to focus on departure clearances, which may be referred to as ARCA-Departure or ARCA-D.

Landing may be the most safety-sensitive point in a flight operation. A number of potential risk factors converge: proximity to ground; low speed and power settings that cause limited maneuverability; high precision required in position, speed, and attitude; concentrated local traffic; and operational pressures such as schedule and fuel. Incidents (or near-accidents) also abound, and some may go unrecorded. Each accident or incident has precursor risk factors that are likely to have been detectable and monitored or recorded by some system at the time of the approach clearance, from glideslope availability to weather and crew experience and equipment anomalies, though the total relevant information available is substantial and is likely to be scattered among various systems and stakeholders. An ARCA system of this disclosure may identify and synthesize large amounts of data from various sources and generate outputs that include indications for appropriate attention when it detects such risk factors.

The approach clearance is associated with a multitude of significant real-time factors, including the following: a specific approach procedure; the current position, speed, and attitude of the aircraft; the specific crew, aircraft, and its equipment; and environmental conditions such as visibility, wind, icing, and runway surface. The approach clearance may be more time-sensitive than some other air traffic control clearances. Generally, the flight crew needs to know within a narrow window of time whether or not it is cleared for a given procedure. On-the-spot good judgment may be required from both the flight crew and controller. Workload may be high and complex for both the flight crew and for air traffic control. On the flight deck, pilots become increasingly invested in a particular anticipated procedure since they perform preparations for the procedure such as programming the flight management system (FMS) and briefing the procedure. One significant advantage of an ARCA system of this disclosure may be to recommend a runway and procedure in advance, so that the flight crew and controllers have their preferences sorted out well ahead of time. For controllers, the heavier the traffic, the more clearances they need to juggle, and the more sensitive their plans are to disruptions.

Performance-Based Navigation (PBN), which is improving system efficiency is, in many ways, making the approach environment more challenging. With new navigation systems (e.g., Global Positioning System (GPS), Ground Based Augmentation System (GBAS)) proliferating, approaches are becoming more technically diverse and complicated. This means that each approach clearance has more options and decision factors than before (such as equipage compatibility with the procedure), increasing the decision and processing load on controllers and pilots. Also, since procedures such as Optimized Profile Descents (OPDs) set the landing process into motion very early and tolerate disturbances poorly, it is more important than ever to select an optimal approach well ahead of time. Furthermore, when OPDs or dense traffic flows are disrupted, controllers suddenly have a lot of decisions to make very quickly. In an air traffic control application, an ARCA system of this disclosure could assist the controller with this decision load. In some implementations, an ARCA system of this disclosure could back up an air traffic controller by analyzing the revised clearances and flagging any high-risk factors that could be missed during high workload. In some implementations, an ARCA system of this disclosure could be a building block of automation that is authorized to recommend and issue certain clearance revisions.

The need for landing risk assessment is anticipated to persist even as the National Airspace System (NAS) transitions from surveillance-based operations (SBO) and clearances to trajectory-based operations (TBO) and clearances. For example, clearances for approach and landing will remain a significant point in operations due to a significant number of dynamic, non-TBO factors such as environmental conditions, the availability of support infrastructure such as Instrument Landing System (ILS) and/or Ground Based Augmentation System (GBAS), crew experience, and aircraft performance. A broad number of decision factors are relevant to risk factors for approach clearances, only a subset of which are typically evaluated during operations, since the total scope of information of all relevant risk factors may be more than a human operator (e.g., airline operations manager, airline dispatcher, pilot, air traffic controller) can manage. Human capacity to evaluate all potential risk factors may be especially limiting when there is time pressure and other safety-critical responsibilities calling for attention. An ARCA system of this disclosure may apply smart, real-time automation of risk factor analysis to clearances and other key decision points, thereby providing human operators with risk factor analysis based on a potentially vast array of relevant real-time and historical data, and more information than a human operator would be capable of evaluating. An ARCA system of this disclosure may thus improve risk factor analysis for aircraft clearances.

An ARCA system of this disclosure may be applicable to a range of applications, such as a decision support tool (DST) for air traffic controllers or pilots, a real-time monitor for operational managers such as dispatchers and air traffic supervisors, or an aggregator for useful periodic reporting, e.g., by airport, by runway, by time period, etc. In some implementations, an ARCA system of this disclosure may play a role in higher levels of actual authority and autonomy for key operational decisions, such as selecting and issuing low-risk approach clearances.

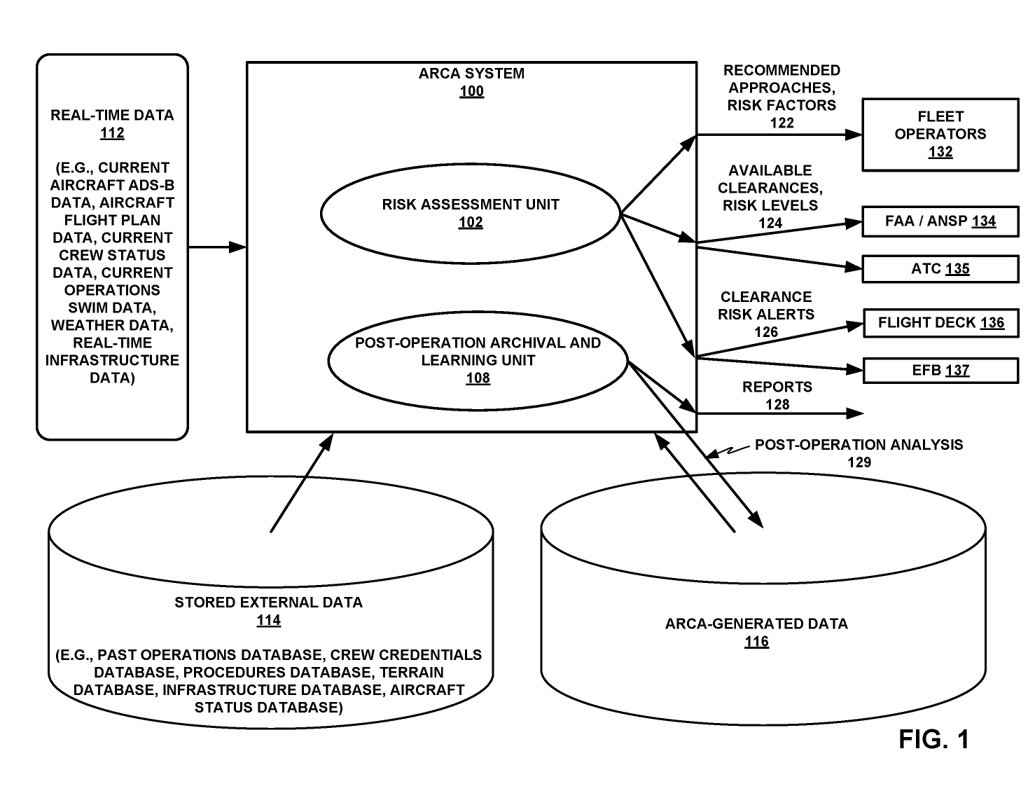

FIG. 1 is a block diagram illustrating an example Automated Real-time Clearance Analyzer (ARCA) system 100, in accordance with aspects of the present disclosure. ARCA system 100 may focus on aircraft approach clearances for incoming air traffic to approach and land on a runway (ARCA-Approach or ARCA-A) or on a different clearance such as departure or arrival, in accordance with aspects of the present disclosure. ARCA system 100 performs a safety analysis of a particular approach clearance based on various types of input data, including real-time data 112 from a variety of real-time data sources, stored external data 114 from databases storing data from various data sources, and stored ARCA-generated data 116 that ARCA system 100 has previously generated based on results of analyses that ARCA system 100 has performed, including through application of machine learning and big data techniques on previously acquired data. ARCA system 100 may thus receive data relevant to an aircraft in flight from a plurality of sources comprising both sources of historical data and sources of real-time data, and potentially also stored ARCA-generated risk data, while the aircraft is being operated.

ARCA system 100 includes risk assessment unit 102 for performing analysis at different stages relative to the flight of an aircraft. As shown in FIG. 1, risk assessment unit 102 of ARCA system 100 may provide different types of outputs for different applications and to different recipients. The various outputs generated by ARCA system 100 may illustratively include recommended approaches and risk factors 122, available clearances and risk levels 124, clearance risk alerts 126, reports 128, and post-operation analyses 129. The various recipients of outputs from ARCA system 100 may include fleet operators 132, the FAA and other ANSPs 134, air traffic control (ATC) 135, and aircraft flight decks 136 and electronic flight bags (EFBs) 137. While FIG. 1 illustratively shows ARCA system 100 communicating certain outputs 122, 124, 126, 128, 129 to certain respective recipients 132, 134, 135, 136, 137, 116, ARCA system 100 may communicate any of the depicted outputs or other outputs to any of the depicted recipients or other recipients in other examples. ARCA system 100 may be implemented on any of various types of a computing system or computing device.

The incoming real-time data 112 may include aircraft surveillance data such as automatic dependent surveillance-broadcast (ADS-B) data from the various aircraft in or near a controlled airspace, aircraft flight plan data, current crew status data, current System Wide Information Management (SWIM) data and/or other operations data, weather data from any type of weather data source, and real-time infrastructure data such as Ground Based Augmentation System (GBAS) data, glideslope status, runway status, for example. The term “real-time” as used herein with reference to various types of real-time data may generally refer to data that is currently and/or recently generated and/or received. For example, ARCA system 100 may receive aircraft ADS-B data on an ongoing basis, which may be considered real-time aircraft surveillance data, and evaluate aircraft trajectories for any one or more aircraft in a controlled airspace based on the ADS-B data for any aircraft in the controlled airspace or associated one or more runways or airports that may continue to be relevant for aircraft still in operation. This may include ADS-B data that is, e.g., several seconds or several minutes old, and is part of the real-time data 101 that ARCA system 100 has received. As another example, ARCA system 100 may evaluate incoming weather data from a variety of sources that may be anywhere up to, e.g., several seconds, several minutes, or an hour or more old, which may be considered part of the real-time data 101 that ARCA system 100 has received. The stored data 114 may include one or more databases of relevant information such as past operations, crew credentials, procedures, terrain, infrastructure, and aircraft types and status, for example.

Some stored data 114 may also be fairly recent and may have been stored fairly recently, e.g., within the previous day or the previous several hours relative to when ARCA system 100 is processing inputs to determine risk factors for a given flight of a given aircraft, or relative to when the given aircraft has a flight plan, is in a controlled airspace, or has been issued a clearance by air traffic control. The division between real-time data and stored data may be arbitrary relative to the functioning of various implementations of ARCA system 100. In some examples, the stored data 114 may be considered to be any data already stored and available to ARCA system 100 prior to ARCA system 100 receiving an identification of a flight to be monitored or receiving a flight plan for a flight to be monitored, while real-time data may be considered to include, e.g., any of the examples of real-time data as described above that ARCA system 100 receives after ARCA system 100 has already received an identification of a flight to be monitored or has received a flight plan for a flight to be monitored.

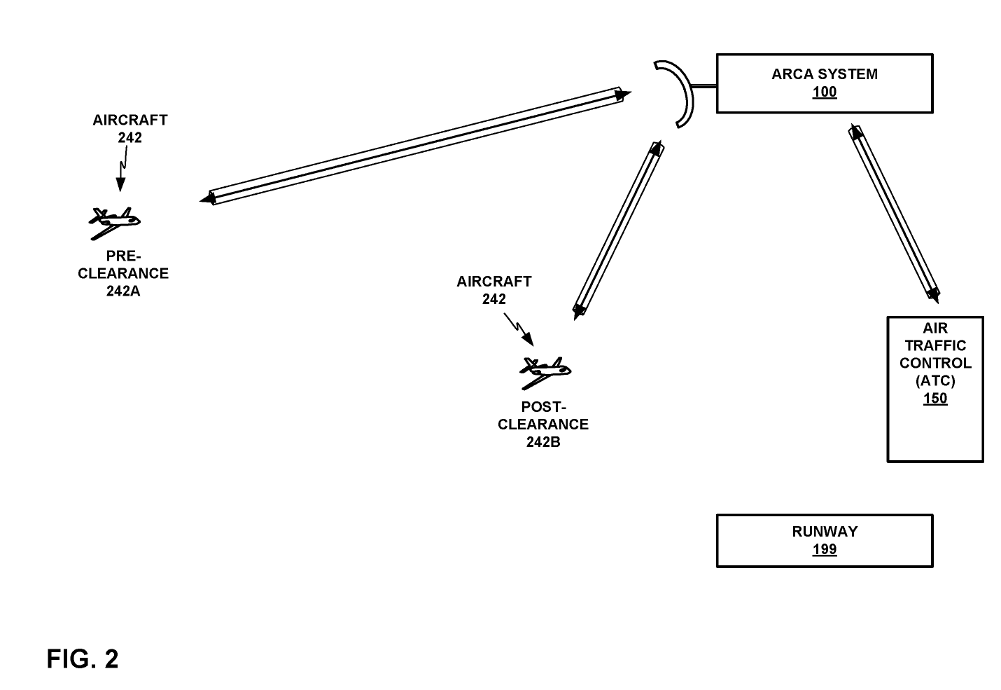

FIG. 2 shows an illustrative example of an ARCA system 100 providing different outputs relative to different phases of flight of an aircraft 242, in accordance with aspects of the present disclosure. Aircraft 242 is shown at an earlier stage of approach (shown at 242A) before it receives a clearance for approach and landing from air traffic control (ATC) 150, and at a later stage of approach (shown at 242B) after it has received its clearance from ATC 150 to approach and land on runway 199. Risk assessment unit 102 of ARCA system 100 may analyze risks associated with or relevant to aircraft 242 throughout its operation before, during, and after a flight, from when operations of aircraft 242 are first planned, to when aircraft 242 first goes into motion from the gate or other initial position at its departure location, and until aircraft 242 comes to rest at the gate or other initial position at its arrival location. The operation analyzed by ARCA 100 may therefore include one or more of being pushed back or towed at a departure location, taxiing at the departure location, takeoff, flight, arrival, approach, landing at an arrival location, taxiing at the arrival location, and/or being pushed back or towed at the arrival location, of aircraft 242. Post-operation unit 108 of ARCA system 100 may generate outputs tailored to be useful after aircraft 242 has landed (not shown in FIG. 2).

Referring again to FIG. 1, the risk assessment unit 102 of ARCA system 100 may begin analyzing a particular aircraft's flight plan once the flight plan is submitted. At this point, there is enough information for ARCA system 100 to begin assessing landing risks and options based on information available at the time. For example, the destination, forecasted weather, aircraft type, and crew are all likely to be known with some certainty. ARCA system 100 may generate outputs for communication to fleet operators 132 such as airlines, in some examples. Fleet operators have a substantial interest in operational risk avoidance. ARCA system 100 may provide fleet operators 132 with a tool to continuously analyze which approach procedures their flights are using and the associated risk levels. This in turn may inform the decision-making of a fleet operator 132, such as what procedures are planned by dispatchers, requested by pilots, and supported by the operators. ARCA system 100 may communicate outputs to a dispatcher tool, which may help dispatchers select approaches in flight planning, provide relevant risk avoidance information to the flight crew, and monitor the risk avoidance of approach clearances as they are delivered. ARCA system 100 may thus generate outputs that include at least one of one or more recommended approaches or one or more identified risk factors associated with one or more available approaches.

ARCA system 100 may continuously, or at one or more intervals, update a risk assessment for a particular flight of an aircraft as the flight progresses. ARCA system 100 may receive and begin with the risk assessment for the particular flight, receive real-time input data 112 as it becomes available, and process the new incoming real-time data 112 to determine modifications to the risk assessment for the flight based on the latest real-time data. ARCA system 100 may generate outputs for communication to air navigation service providers (ANSPs) such as the Federal Aviation Administration (FAA) in the U.S. ARCA system 100 may generate outputs for communication to air traffic control (ATC). In some examples, flight in progress unit 104 may determine a high risk condition for the flight, above a certain threshold of risk level, and may, in response to determining that the high risk condition exists, output a recommendation or request for a change in procedure and/or a change in runway for the flight.

ARCA system 100 may output such a recommendation or request for a change in procedure and/or a change in runway for the flight for communication to pilots, operations managers, or to air traffic control, in implementations in which air traffic control is prepared to receive information from ARCA system 100. ARCA system 100 may output such a recommendation for a change in procedure and/or a change in runway for the flight for communication to the FAA or other ANSP, which may use the information from ARCA system 100 to assess or track risk factors associated with the flights. In implementations in which ARCA system 100 is configured to provide information to air traffic control, ARCA system 100 may output for communication to air traffic control a list of available clearances and a risk level associated with each of the available clearances, with highlighted indications of any specific high-risk factors associated with any of the available clearances. ARCA system 100 may thus generate outputs that include at least one of one or more available clearances or one or more identified levels of risk associated with one or more available clearances.

ARCA system 100 may be configured to receive or detect communications from air traffic control via, e.g., datalink, System Wide Information Management (SWIM), including when air traffic control issues a clearance (e.g., a clearance for approach and landing) for an aircraft. ARCA system 100 may respond to issuance of a clearance for an aircraft by processing ongoing risk analysis for the aircraft. ARCA system 100 may track and process data relevant to the flight of the aircraft in the context of an issued clearance, such as by comparing the aircraft's trajectory, positions over time, rate of descent, or other flight parameters with the corresponding flight parameters specified by the assigned clearance.

ARCA system 100 may generate outputs for communication to an EFB of the flight crew, or to another system onboard the flight deck of the aircraft it is tracking, or to a dispatcher, or to an air traffic controller, in various examples. In some examples, the EFB may be implemented as an application or interface executing on a tablet computer or other mobile device used by the flight crew, and ARCA system 100 may be configured to communicate data to the EFB mobile device interface. ARCA system 100 may determine if risks associated with the approach clearance exceed a specified threshold. Delivered clearance unit 106 may respond to determining that risks associated with the approach clearance exceed the specified threshold by generating a warning or alert output for communication to the EFB, other flight deck interface, or dispatcher interface. This warning or alert output may contain highlights of the analysis such as exceptional risk factors, e.g., a message indicating, “Relatively short runway and surface conditions poor for braking.” The warning or alert output may also recommend one or more alternative approach options that ARCA system 100 determines to have lower risk. ARCA system 100 may set an appropriately high threshold for issuing a warning or alert output to avoid recommending modifying the flight after the clearance is issued unless ARCA system 100 determines that the risks are identified with a sufficient level of certainty and that the modification is genuinely warranted by the determined risks. ARCA system 100 may also include safeguards against issuing false alarms. Pilots, dispatchers, air traffic controllers, or other operators may use this information in a range of ways, from simply exercising increased caution to requesting or issuing a different clearance.

ARCA system 100 may output such a recommendation for a change in procedure and/or a change in runway for the flight for communication to the FAA or other ANSP, which may use the information from ARCA system 100 to assess or track risk factors associated with the approach clearances. In some examples, ARCA system 100 may determine that a single risk factor is clearly sufficient to fulfill a threshold or criterion for outputting a warning or alert, for risk factors such as a clearance that is incompatible with equipage or infrastructure, that conflicts with other clearances or air traffic, or that violates minimums.

In some examples, even where there is no single risk factor that fulfills a criterion for outputting an alert, ARCA system 100 may determine that a combination of detected risk factors elevates the overall risk above a selected threshold. For example, ARCA system 100 may determine that there are adverse weather conditions (e.g., gusty winds), that the runway specified in the clearance has poor conditions (e.g., accumulated precipitation), and that the aircraft crew has little experience, and that those factors in combination, compared with probabilistic modeling based on historical data, justify issuing an alert. ARCA system 100 may also determine that a different runway at the airport has better runway conditions, and may issue a recommendation, together with the alert, for the clearance to be modified for the aircraft to approach the runway with better runway conditions. ARCA system 100 may generate this alert and recommendation after determining also that the combination of risk factors involved in modifying the clearance and having the aircraft land at the other runway would be sufficiently lower than the risk factors of the original clearance as to justify the alert and recommendation to modify the clearance. ARCA system 100 may issue the alert and recommendation to modify the clearance to the EFB or other flight deck interface, and the flight crew may respond by requesting air traffic control to modify the clearance.

In some cases, pilots may be aware of risk factors associated with approach clearances, but not always, especially if there are unfamiliar circumstances (e.g., unfamiliar airport, unfamiliar procedure) or high workload (cabin distractions, communication issues). Outputs from ARCA system 100 to the EFB or other flight deck interface may provide backup intelligence to the flight crew to promote the flight crew's awareness of risk factors and overall risk. For example, ARCA system 100 may integrate multiple risk factors that combine into a substantial overall risk, such as short runway, wet conditions, low visibility, and curved approach, and determine to generate a warning output for communication to the EFB or other flight deck interface to warn of and describe the risk factors and recommend caution. For example, ARCA system 100 may generate a warning output for communication to the EFB or other flight deck interface, implemented as a text and/or spoken word output, that says, e.g., “Landing Caution: wet surface, short runway. Avoid landing long and ensure traction on touchdown.” A warning output such as this from ARCA system 100 to a flight crew interface may serve to heighten the crew's awareness of relevant risks, and potentially prepare the flight crew to be ready to carry out a go-around procedure instead of landing on the initial approach if the approach and landing does not develop with sufficient containment of the identified risks.

In other examples, ARCA system 100 may issue the alert and recommendation to modify the clearance directly to air traffic control, or to a dispatcher or an airline operations manager, who may determine whether to send the information and request to the air traffic controller and/or the flight crew. In some implementations, ARCA system 100 may be integrated with air traffic control systems to generate automated approach clearances based on its determination of what approach clearance options would reduce or minimize overall risks. ARCA system 100 may generate automated approach clearance outputs to an air traffic controller interface configured to receive an air traffic controller input to confirm or override the approach clearance generated by ARCA system 100. In some examples, ARCA system 100 may support automated traffic management (ATM).

The post-operation unit 108 of ARCA system 100 may monitor the outcome of the approach and landing, for each of a number of flights that ARCA system 100 processes, and may process the outcome of the approach and landing in association with the relevant data, risk factors, and/or real-time ARCA outputs 122, 124, 126 for that flight. Post-operation unit 108 may generate post-operation analysis 129 and/or periodic reports 128 based on its processing of the results of the flights in association with the relevant data, risk factors, and/or real-time ARCA outputs. Post-operation unit 108 may determine relationships among certain relevant factors, precursors, and incidents (such as deviation from path, proximity to obstructions, landing long, hard landing, excessive acceleration, etc.). Post-operation unit 108 may use the results of its analysis of relevant factors to modify or refine (by “learning”) a probabilistic network, e.g., one or more Bayesian networks, that ARCA system 100 uses to determine risks based on relevant factor data, as further described below.

Post-operation unit 108 may generate post-operation analysis 129 may store the results of risk analysis by ARCA system 100 in one or more databases or data stores of ARCA-generated data 116. ARCA system 100 may continue to draw from and process ARCA-generated data 116 together with other long-term stored data 114 and real-time data 112 to perform ongoing analysis processing.

Post-operation unit 108 may generate reports or analyses over substantial scales of time and area and may identify times or areas that involve higher risks. For example, post-operation unit 108 may identify specific areas in the NAS or in a region, times of day, procedures, or aircraft types that are associated with higher risk relative to the average or a baseline. ARCA system 100 may communicate these reports or analyses generated by post-operation unit 108 to airlines or other fleet operators, airport operators, air traffic control authorities, FAA air traffic management, aircraft manufacturers, or other aviation stakeholders or interested entities. ARCA system 100 may generate reports tailored to the specific interests or specifications of any one or more of these recipients, and may do so on periodic intervals or in response to specific requests. ARCA system 100 may thus perform a risk analysis after the aircraft has landed, and generate outputs that include one or more reports 128 summarizing sets of risk analyses for a plurality of flights and/or adding additional data to ARCA-generated data store 116 of generated data available to be used to modify the Bayesian network model.

ARCA system 100 may thus combine decision factors to produce a real-time, context-specific risk assessment for an aircraft while it is in flight. The recentness of the data accessed and used by ARCA system 100 may depend on the type of data. For some sources such as weather, ARCA system 100 accesses and uses data that is real-time or recent, and in some examples, as recent as possible, since some risk-relevant weather conditions such as wind or convective weather may be short-lived and/or may rapidly change. ARCA system 100 accesses and uses data that is real-time or recent, and in some examples, as recent as possible, for infrastructure data, such as glideslope status and runway status. For example, if a glideslope is turned off or runway debris is discovered, it may be immediately relevant as a potential risk factor.

ARCA system 100 accesses and uses data that is real-time or recent, and in some examples, as recent as possible, for aircraft data, both for a particular aircraft involved in a particular flight that ARCA system 100 is tracking, and for other surrounding aircraft in the air traffic in which the particular aircraft is flying. Aircraft data may include a wide range of information. Some relevant aircraft information may change continuously, such as position, velocity, and other flight parameters and ARCA system 100 may be configured to access that aircraft flight parameter data in real-time. Other relevant aircraft data may not be as time-sensitive, such as performance characteristics, age, and maintenance record. The sources of historical data represented in FIG. 1 by stored historical data 114 may include data on past aircraft operations, past airport operations, past procedures, terrain, infrastructure, aircraft type, aircraft status, past clearances and associated outcomes, crew training and credentials, crew country of origin, and how many years of experience the flight crew have in performing their current functions, for example.

Different data about the flight crew has different time sensitivity. ARCA system 100 may access and use data that is real-time or recent (e.g., updated within past 12 hours) for crew schedule and how long the crew have been on duty, while ARCA system 100 may access and use data from longer-term historical databases for information such as crew training and credentials, crew country of origin, and how many years of experience the flight crew have in performing their current functions. ARCA system 100 may access and use some past operations data from historical information (e.g., how often a given clearance has been used and how successful), some past operations data from more or less time-sensitive or real-time data sources (for example, if there have been problems with a given clearance in the past few days due to some temporary circumstance). Further details about data sources and processing constructs used by ARCA system 100 to process the data are discussed below.

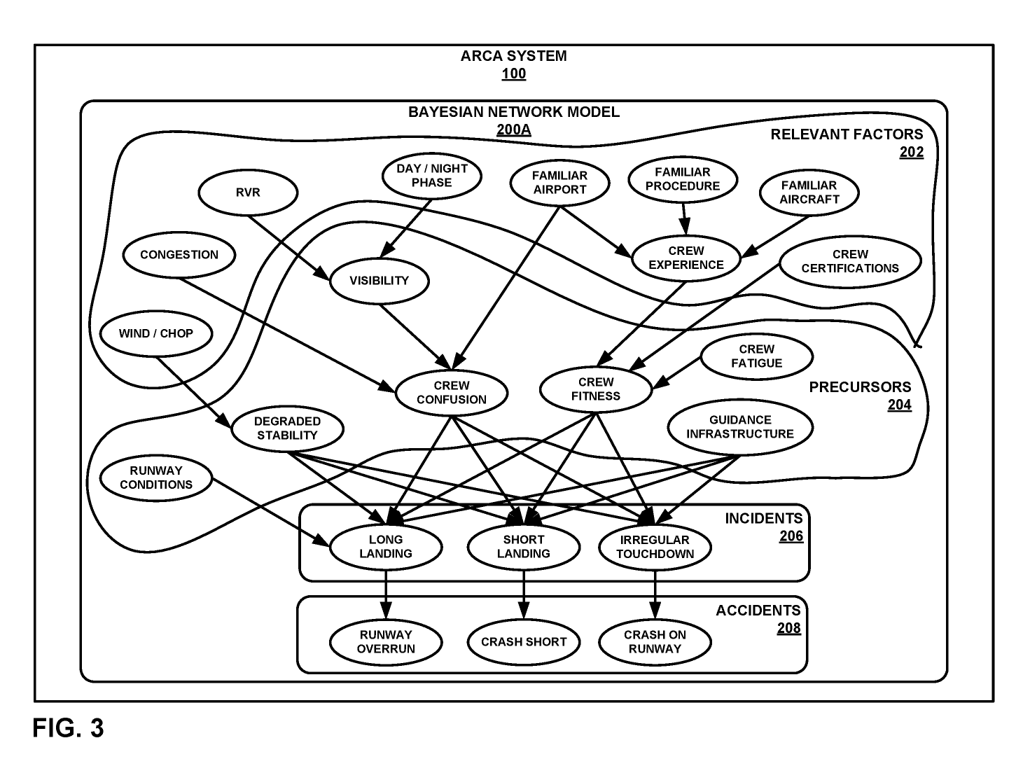

While some examples of risk assessment unit 102 of ARCA system 100 generating outputs for communication to certain recipients are described above, ARCA system 100 may generate outputs for communication to any of the recipients described above or other recipients in other examples. ARCA system 100 may use a Bayesian network model, as further described below with reference to FIGS. 2 and 3.

FIG. 3 shows an implementation of ARCA system 100 comprising a Bayesian network (BN) model 200A that ARCA system 100 may use to assess clearance for approach and landing of an aircraft, in accordance with aspects of the present disclosure. Bayesian network model 200A includes a set of nodes, which represent variables for various factors and results, and a set of directed links (shown as arrows between nodes), which model the conditional dependencies between the variables. The exact nodes and connections may vary in different examples within the scope of the concept of ARCA system 100. Each node that has dependencies, or child node, is associated with a probability function which takes as input a set of values for that node's parent nodes and gives the consequent conditional probability distribution (CPD) of the variable associated with the node. The conditional dependencies between the variables in the graphical model are quantified using conditional probability distributions, which ARCA system 100 may compute from historical data. The nodes of Bayesian network model 200A represent quantities of interest, and the directed links between the nodes represent the major probabilistic associations between the nodes.

Though Bayesian networks are useful for a wide range of applications, many applications do not involve performing analysis and generating outputs in real-time. In this example, Bayesian network model 200A may be a causal learning network. It is a causal network because it seeks to determine operational factors that may directly contribute and lead to accidents and to off-nominal incidents or precursors that are potential causative of accidents. Causal networks have causative relationships between nodes (e.g. “x” contributes to causing “y”) and thus are relevant to analyzing how to intervene and re-direct or interrupt the flow of causality that might potentially lead to an accident. ARCA system 100 may also apply machine learning to causal Bayesian networks to refine or modify the Bayesian networks and perform Bayesian updating based on additional data as it is received by ARCA system 100.

The nodes of Bayesian network model 200A represent relevant factors or quantities of interest in the approach clearance assessment. The nodes represent information that answers relevant criteria for analysis, such as, does an aircraft have good Instrument Landing System (ILS) and/or Ground Based Augmentation System (GBAS) support? Are there hazardous obstructions (e.g., terrain or structures)? Is the crew experienced or not with the current aircraft, airport, or procedures? Some of the quantities of interest represented by the nodes may be represented by Boolean variables (true or false) or discrete rather than continuous quantities, where those accurately represent the underlying values, which may also contribute to reducing the complexity or processing burden of performing network calculations with Bayesian network model 200A. In some examples, the nodes and links of Bayesian network model 200A may be improved or refined over time based on ongoing learning by ARCA system 100 and/or analysis of ARCA system 100. The nodes shown in FIG. 3 are an illustrative example, and a wide variety of nodes and directed links may be used in different implementations of ARCA 100.

In the example of FIG. 3, the nodes are divided into specific node types, which include various relevant factor nodes 202, various precursor nodes 204, various incident nodes 206, and various accident nodes 208. Relevant factor nodes 202 represent a wide variety of input data from various data sources, including both database or archival data and real-time data. Relevant factor nodes 202 may also include dependent nodes that are computed based on the independent input data nodes. For example, FIG. 3 shows a “crew experience” dependent node that may be calculated based on dependencies from various crew experience nodes representing types of input data on the experience of a flight crew, such as the crew's familiarity with the airport, the crew's familiarity with the procedure being performed, and the crew's familiarity with the aircraft. Other representative independent input data nodes included in relevant factor nodes 202 in the example of FIG. 3 are wind/chop, congestion, Runway Visual Range (RVR), day/night phase, crew certifications, and crew fatigue.

Precursor nodes 204 represent potential risk factors that may serve as precursors or contributing causes of incidents or accidents. Precursor nodes 204 may also include both independent input data nodes and dependent data nodes. Precursor nodes 204 in the example of FIG. 3 include input data precursor nodes such as runway conditions, crew fatigue, and guidance infrastructure; and dependent precursor nodes such as degraded stability, visibility, crew confusion, and crew fitness.

Incident nodes 206 include a long landing node, a short landing node, and an irregular touchdown node. Accident nodes 208 include a runway overrun crash node, a crash short of the runway node, and a crash on the runway node, which have causative links from the long landing node, the short landing node, and the irregular touchdown node, respectively. That is, the types of crash are divided between the respective types of off-nominal landings or touchdowns, where the accidents may be extreme outliers of the off-nominal landings or touchdowns. Some of the precursors affect the probabilities of each of the three types of incidents, potentially in different ways, whereas some precursors may affect the probabilities of only a subset of the incidents, such as runway conditions only affecting the probabilities of a long landing, as modeled in Bayesian network 200A.

The divisions into the node groups 202, 204, 206, 208 (“node groups 202-208”) reflect that ARCA system 100 may trace causal progressions from initial relevant factors or circumstances, to precursors, to incidents, to accidents. This both maps well to reality, and also contributes to identifying statistically meaningful sample sets of chains of cause and effect among relevant factors, precursors, and incidents in operations that have the potential to lead to accidents. Even if we are ultimately interested in accident risk, the data for accident occurrences is sparse since aircraft accidents are rare, but precursors and off-nominal incidents are far more common, and mark noteworthy steps in a causal chain of events that could potentially ultimately cause an accident. For example, a runway overrun (an accident) is an extreme case of a long landing (an incident). Both may be strongly influenced by one or more precursors, such as unusually poor surface conditions on the runway. ARCA system 100 may perform probabilistic mapping of precursor and incident data as causative factors that could potentially lead to accidents in analogous situations, which supplements the sparser data from actual accidents in providing a rich overall data set for modeling conditions that lead to accidents.

In Bayesian network model 200A, a directed link does not imply that one leads to another. For example, Bayesian network model 200A as shown in FIG. 3 does not imply that a “familiar airport” leads to “crew confusion.” Rather, the directed link leading from the familiar airport node (with input data on a particular crew's familiarity with the particular airport) to the crew confusion node captures the fact that there is a probabilistic influence from the familiar airport node to the crew confusion node. In this case, a low value, or a Boolean value of “false,” for the familiar airport node, may increase the probability of a higher value or a Boolean value of “true” for “crew confusion.”

Bayesian network model 200A may thus include a network of nodes connected by directed links, wherein the nodes include relevant factor nodes that model relevant factors, precursor nodes that model precursors, incident nodes that model incidents, and accident nodes that model accidents. The directed links may include directed links from the relevant factor nodes to the precursor nodes, directed links from the precursor nodes to the incident nodes, and directed links from the incident nodes to the accident nodes. The directed links may also include other directed links, such as directed links within the relevant factor nodes, and directed links within the precursor nodes.

ARCA system 100 may apply various techniques to improve the nodes and structure of Bayesian network model 200A, which may include one Bayesian network as shown in FIG. 3 or may include a plurality of Bayesian networks in other examples. ARCA system 100 may be configured to apply machine learning (ML) techniques with input data patterns from incidents and accidents (e.g., data from the Aviation Safety Reporting System (ASRS)) to refine or improve Bayesian network model 200A. ARCA system 100 may apply Bayesian network model 200A not only to predict the probability of incidents and accidents before they occur, but also, with post-operation unit 108, to determine or refine the values and conditional probability distributions of relevant factors and precursors after they occur, and potentially also to modify the probabilistic relationships within or topology of Bayesian network model 200A. ARCA system 100 may perform Bayesian updating of its probabilistic inference model as ARCA system 100 receives more and more data. Thereby, ARCA system 100 may learn and become more accurate over time. For example, post-operation unit 108 may mine large data sets to determine whether new short landing criteria define acceptable landing conditions, and define proposed new short landing criteria that ARCA system 100 determines do not pose an elevated risk relative to other accepted landing criteria. ARCA system 100 may output the proposed new short landing criteria based on its analysis to aviation authorities such as air traffic control or the FAA air traffic management.

ARCA system 100 may also modify the topology of Bayesian network model 200A such as by identifying multiple, finer distinguishing factors in the data represented by a single node and splitting that node into two or more nodes, and modifying the directed links or values associated with the new nodes and links, or by identifying previously unidentified relevant elements and patterns in input data nodes and adding new nodes and/or new directed links to represent those new elements or patterns from the data, for example. ARCA system 100 may also identify precursors by evaluating patterns in aircraft surveillance data, for example. ARCA system 100 may feed occurrences (and non-occurrences) of a precursor directly back into Bayesian network model 200A to train Bayesian network model 200A for the probabilistic connections involved, or the conditional probability distributions of the directed links to and from the precursors. Thus, in some examples, the longer ARCA system 100 operates or the more operational data ARCA system 100 acquires, the more accurate ARCA system may become in assessing risks.

ARCA system 100 may thus receive additional data and compare the additional data with outcomes modeled by the Bayesian network model. In some examples, ARCA system 100 may perform Bayesian updating of conditional probability distributions associated with the directed links based on results of comparing the additional data with outcomes modeled by Bayesian network model 200. In some examples, ARCA system 100 may perform a modification of Bayesian network model 200A based on results of comparing the additional data with the outcomes modeled by the Bayesian network model 200A, where the modification may include at least one of adding a new directed link between two of the nodes, adding a new node with a new directed link with another one of the nodes, removing one of the directed links, or removing one of the nodes with at least one of the directed links.

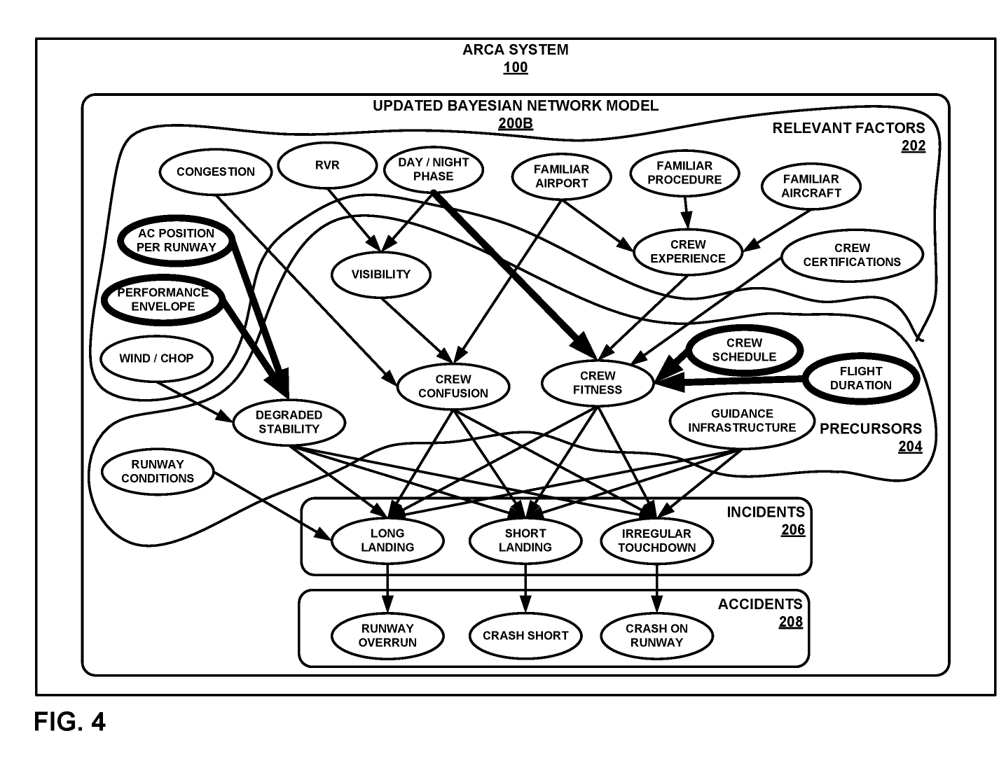

ARCA system 100 may also apply big data techniques to process potentially sparse data such as data relevant to accidents from among the total data, and to perform accurate Bayesian updating of Bayesian network model 200 based on the potentially sparse accident data. Greater volumes of operational data are becoming available over time, which ARCA system 100 may monitor and process as input data. ARCA system 100 may also be fed historical data of landing precursors, such as airport operations data collections, each of which may include a wide variety of data on, e.g., several years' worth of aircraft operations at an airport. ARCA system 100 may use multiple ways to interpret and map past data from across large areas such as the National Airspace System (NAS) into Bayesian network model 200A, as further described below with reference to FIG. 4. ARCA system 100 may thus receive additional data, perform a MapReduce operation to process the additional data, and revise Bayesian network model 200 based at least in part on results of the MapReduce operation to process the additional data.

FIG. 4 shows ARCA system 100 with a newly revised Bayesian network model comprising revisions that ARCA system 100 makes to its Bayesian network model 200 over time by applying techniques such as Bayesian updating, machine learning, and/or big data techniques to the Bayesian network model 200A as shown in FIG. 3, resulting in an updated Bayesian network model 200B, in accordance with aspects of the present disclosure (where “Bayesian network model 200” refers to the model in general over time, as opposed to at a particular time). FIG. 4 shows new modifications ARCA system 100 has made to Bayesian network model 200 in bold lines, as further described below. As ARCA system 100 updates an increasing number of nodes as an operation progresses, Bayesian network model 200 may produce an increasingly specific and appropriate risk estimate, embodied in output nodes for “Incidents” and “Accidents.” ARCA system 100 may use big data techniques to identify and model multiple correlations. For example, ARCA system 100 may track long landings for a specific runway and approach. ARCA system 100 may determine that an operation currently underway matches the weather conditions, crew experience, runway, and procedure factors that led to a long landing 5 years ago. ARCA system 100 may also apply big data techniques to evaluate and determine probabilistically how often the same or closely similar conditions (similar weather, crew, runway length, and procedure type) led to long landings throughout the NAS (or other available geographic range) and throughout the available history. For example, ARCA system 100 may apply a range of estimators and information processing to distill the quantities used in Bayesian network model 200. (Bayesian network models 200A and 200B as shown in FIGS. 2 and 3 and as the Bayesian network model of ARCA system 100 might otherwise be updated or modified over time may generically be referred to as Bayesian network model 200 for purposes of this disclosure.)

ARCA system 100 may include features for users to access and view many or all of the relevant aspects of its functioning, including of the structure of Bayesian network model 200, the data being used for the input nodes, the conditional probability distributions of the directed links, a log of the changes that ARCA system 100 has made to Bayesian network model 200 over time, and the analyses providing the rationales for those changes. ARCA system 100 may support an offline replay feature that outputs its determinations of how it has modified the values, conditional probability distributions, or topology of Bayesian network model 200 over time, such that human users may analyze and verify any aspect of the operations and the learning of ARCA system 100. Transparency features such as these of ARCA system 100 may enable users to tune or modify how ARCA system 100 operates and learns, detect and correct any errors, and perform analysis to support verification for quality assurance.

As noted above, ARCA system 100 may also include features to prevent or inhibit false alarms. ARCA system 100 may provide some outputs in the form of information on risk factors for delivery to user interfaces of decision makers. ARCA system 100 may provide other outputs in the form of alarms if ARCA system 100 determines that operational data clearly indicate a justification for an alarm, such as a clear set of risks that may require an urgent action or change of course or change of procedure to avoid. In some examples, ARCA system 100 may provide outputs such as alarm outputs only to users who may review its determinations before either forwarding or approving the outputs for delivery to end users, such as a flight crew, or overriding the determination by ARCA system 100. In some examples, ARCA system 100 may provide outputs in the form of periodic reports to operations managers. In some examples, ARCA system 100 may provide real-time outputs to operational end-users such as pilots, dispatchers, and/or air traffic controllers.

ARCA system 100 may also include features to address unavailable data or low-quality data. If data for an input node is unavailable, ARCA system 100 proceeds with making calculations based on all the rest of the probabilities in Bayesian network model 200 without making assumptions about the missing data. To address low-quality data, ARCA system 100 may be implemented with correction factors or filters to apply to low-quality data to correct for known biases or other data quality issues and/or filter the low-quality data in appropriate ways, such as by applying criteria to determine the quality of the data and then either using, correcting, or rejecting the data based on that determination.

ARCA system 100 may thus build on and apply several broad research areas that are relevant to safe real-time aviation operations: probabilistic or Bayesian network modeling, emerging real-time connectivity with disparate information sources, and data mining/big data research. ARCA system 100 may provide prognostic decision supports, data mining, data discovery, and machine learning to identify opportunities for improvement in airspace operational predictions of risky conditions for vehicles, airspace, and dispatch operations.

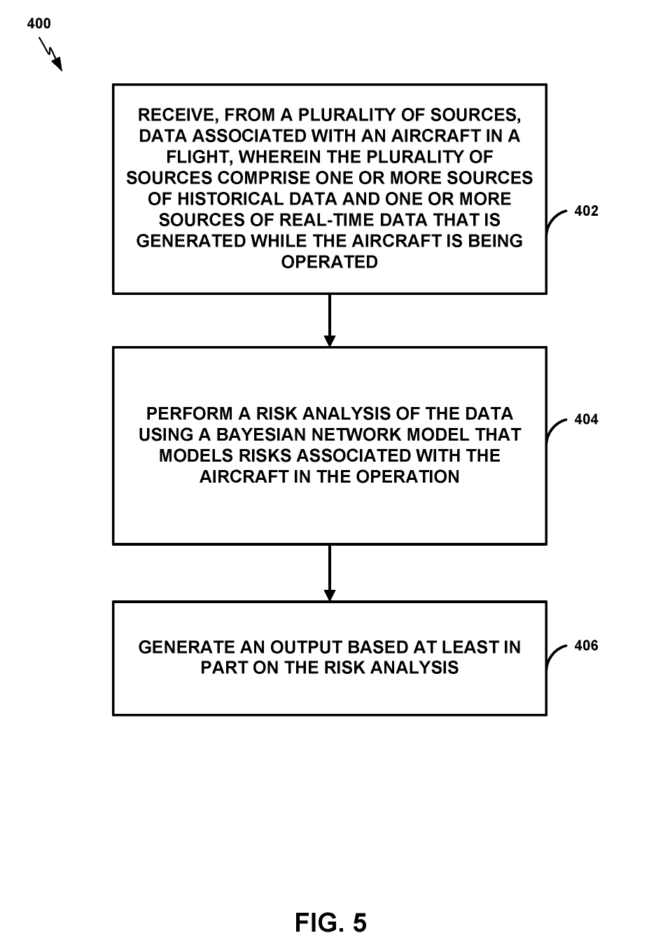

FIG. 5 is a flowchart of an example process 500 that ARCA system 100 (e.g., as in any of FIGS. 1-4) may perform, in accordance with aspects of the present disclosure. In this example, ARCA system 100, implemented by a computing device comprising one or more processors, receives, from a plurality of sources, data associated with an aircraft that is in an operation, wherein the plurality of sources comprises one or more sources of historical data and one or more sources of real-time data that is generated while the aircraft is in the operation (e.g., ARCA system 100 receives input data 101 including aircraft FMS data, flight crew certification data, flight data, schedule data, etc. for an aircraft 242 during an operation that includes operation of the aircraft 242 before, during, and after a flight, including one or more of being pushed back or towed at a departure location, taxiing at the departure location, takeoff, flight, approach, landing at an arrival location, taxiing at the arrival location, and/or being pushed back or towed at the arrival location) (402). ARCA system 100 may then perform a risk analysis of the data using a Bayesian network model that models risks associated with the aircraft in the operation (e.g., ARCA system 100 performs a risk analysis based on Bayesian network model 200 for aircraft 242 in the operation) (404). ARCA system 100 may then generate an output based at least in part on the risk analysis (e.g., ARCA system 100 generates one or more of: an output 122 that includes one or more of one or more recommended approaches and/or one or more risk factors associated with one or more available approaches; an output 124 that includes one or more available clearances and/or one or more levels of risk associated with one or more available clearances; an alert or warning 126 indicating a risk associated with an issued clearance; a report 128 summarizing risk analyses generated by ARCA system 100 for one or more flights; and/or one or more post-operation risk analyses 129 that ARCA system 100 stores to be available to ARCA system 100 for revising or modifying its risk modeling, e.g., by performing Bayesian updating of Bayesian network 200 to incorporate and benefit from the additional new data involved in the risk analyses of flights performed by ARCA system 100; and, e.g., ARCA system 100 generates one or more of these outputs for communication to one or more of the aircraft in the flight, an interface for a fleet operator of the aircraft, an air traffic control (ATC) authority, or an air navigation service provider (ANSP)) (406).

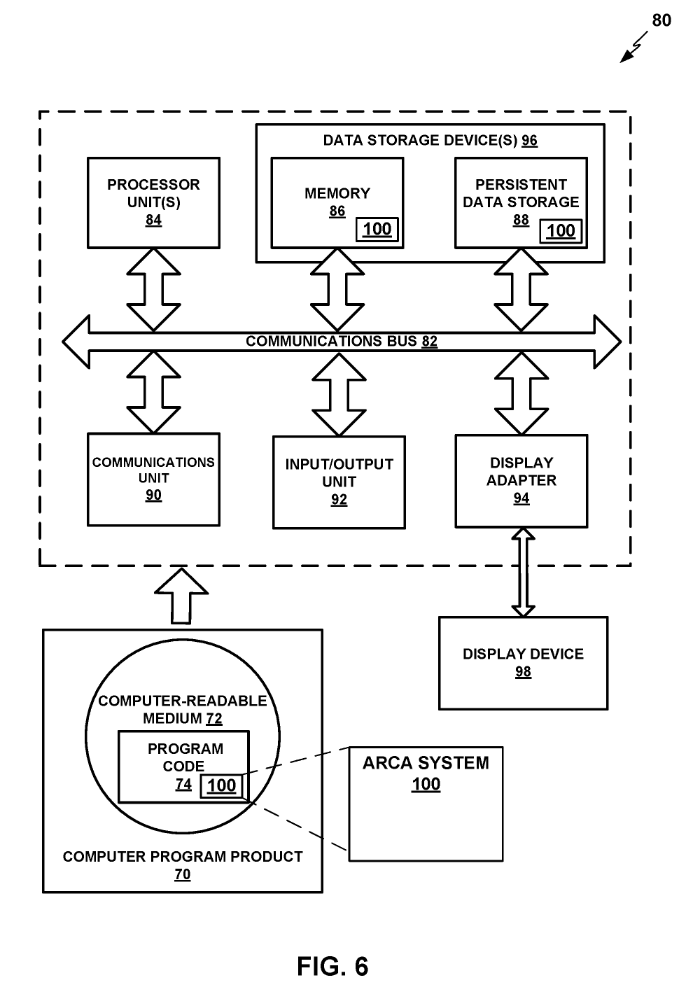

FIG. 6 is a block diagram of a computing device 80 that may be used to host and/or execute an implementation of ARCA system 100 as described above with reference to FIGS. 1-5, in accordance with aspects of the present disclosure. In various examples, ARCA system 100 hosted and/or executing on computing device 80 may perform at least some of the functions described above. Computing device 80 may be a laptop computer, desktop computer, or any other type of computing device. Computing device 80 may also be a server in various examples, including a virtual server that may be run from or incorporate any number of computing devices. A computing device may operate as all or part of a real or virtual server, and may be or incorporate a specialized air traffic control workstation, other workstation, server, mainframe computer, notebook or laptop computer, desktop computer, tablet, smartphone, feature phone, or other programmable data processing apparatus of any kind. Other implementations of a computing device 80 may include a computer or device having capabilities or formats other than or beyond those described herein.

In the illustrative example of FIG. 6, computing device 80 includes communications bus 82, which provides communications between one or more processor units 84, memory 86, persistent data storage 88, communications unit 90, and input/output (I/O) unit 92. Communications bus 82 may include a dedicated system bus, a general system bus, multiple buses arranged in hierarchical form, any other type of bus, bus network, switch fabric, or other interconnection technology. Communications bus 82 supports transfer of data, commands, and other information between various subsystems of computing device 80.

Processor unit 84 may be a programmable central processing unit (CPU) configured for executing programmed instructions stored in memory 86. In another illustrative example, processor unit 84 may be implemented using one or more heterogeneous processor systems in which a main processor is present with secondary processors on a single chip. In yet another illustrative example, processor unit 84 may be a symmetric multi-processor system containing multiple processors of the same type. Processor unit 84 may be a reduced instruction set computing (RISC) microprocessor, an x86 compatible processor, or any other suitable processor. In various examples, processor unit 84 may include a multi-core processor, such as a dual core or quad core processor, for example. Processor unit 84 may include multiple processing chips on one die, and/or multiple dies on one package or substrate, for example. Processor unit 84 may also include one or more levels of integrated cache memory, for example. In various examples, processor unit 84 may comprise one or more CPUs distributed across one or more locations.

Data storage device 96 includes memory 86 and persistent data storage 88, which are in communication with processor unit 84 through communications bus 82. Memory 86 can include a random access semiconductor memory (RAM) for storing application data, i.e., computer program data, for processing. While memory 86 is depicted conceptually as a single monolithic entity, in various examples, memory 86 may be arranged in a hierarchy of caches and in other memory devices, in a single physical location, or distributed across a plurality of physical systems in various forms. While memory 86 is depicted physically separated from processor unit 84 and other elements of computing device 80, memory 86 may refer equivalently to any intermediate or cache memory at any location throughout computing device 80, including cache memory proximate to or integrated with processor unit 84 or individual cores of processor unit 84.

Persistent data storage 88 may include one or more hard disc drives, solid state drives, flash drives, rewritable optical disc drives, magnetic tape drives, or any combination of these or other data storage mediums. Persistent data storage 88 may store computer-executable instructions or computer-readable program code for an operating system, application files including program code, data structures or data files, and any other type of data. These computer-executable instructions may be loaded from persistent data storage 88 into memory 86 to be read and executed by processor unit 84 or other processors. Data storage device 96 may also include any other hardware elements capable of storing information, such as, for example and without limitation, data, program code in functional form, and/or other suitable information, either on a temporary basis and/or a permanent basis.

Persistent data storage 88 and memory 86 are examples of physical computer-readable data storage devices. Data storage device 96 may include any of various forms of volatile memory that may require being periodically electrically refreshed to maintain data in memory, while those skilled in the art will recognize that this also constitutes an example of a physical computer-readable data storage device. Executable instructions may be stored on a physical medium when program code is loaded, stored, relayed, buffered, or cached on a physical medium or device, including if only for only a short duration or only in a volatile memory format.

Processor unit 84 can also be suitably programmed to read, load, and execute computer-executable instructions or computer-readable program code for an ARCA system 100, as described in greater detail above. This program code may be stored on memory 86, persistent data storage 88, or elsewhere in computing device 80. This program code may also take the form of program code 74 stored on computer-readable medium 72 included in computer program product 70, and may be transferred or communicated, through any of a variety of local or remote means, from computer program product 70 to computing device 80 to be enabled to be executed by processor unit 84, as further explained below. Computer program product 70 may be a computer program storage device in some examples.

The operating system may provide functions such as device interface management, memory management, and multiple task management. The operating system can be a Unix based operating system, a non-Unix based operating system, a network operating system, a real-time operating system (RTOS), or any other suitable operating system. Processor unit 84 can be suitably programmed to read, load, and execute instructions of the operating system.

Communications unit 90, in this example, provides for communications with other computing or communications systems or devices. Communications unit 90 may provide communications through the use of physical and/or wireless communications links. Communications unit 90 may include a network interface card for interfacing with a local area network (LAN), an Ethernet adapter, a Token Ring adapter, a modem for connecting to a transmission system such as a telephone line, or any other type of communication interface. Communications unit 90 can be used for operationally connecting many types of peripheral computing devices to computing device 80, such as printers, bus adapters, and other computers. Communications unit 90 may be implemented as an expansion card or be built into a motherboard, for example.

The input/output unit 92 can support devices suited for input and output of data with other devices that may be connected to computing device 80, such as keyboard, a mouse or other pointer, a touchscreen interface, an interface for a printer or any other peripheral device, a removable magnetic or optical disc drive (including CD-ROM, DVD-ROM, or Blu-Ray), a universal serial bus (USB) receptacle, or any other type of input and/or output device. Input/output unit 92 may also include any type of interface for video output in any type of video output protocol and any type of monitor or other video display technology, in various examples. It will be understood that some of these examples may overlap with each other, or with example components of communications unit 90 or data storage device 96. Input/output unit 92 may also include appropriate device drivers for any type of external device, or such device drivers may reside elsewhere on computing device 80 as appropriate.

Computing device 80 also includes a display adapter 94 in this illustrative example, which provides one or more connections for one or more display devices, such as display device 98, which may include any of a variety of types of display devices. It will be understood that some of these examples may overlap with example components of communications unit 90 or input/output unit 92. Input/output unit 92 may also include appropriate device drivers for any type of external device, or such device drivers may reside elsewhere on computing device 80 as appropriate. Display adapter 94 may include one or more video cards, one or more graphics processing units (GPUs), one or more video-capable connection ports, or any other type of data connector capable of communicating video data, in various examples. Display device 98 may be any kind of video display device, such as a monitor, a television, or a projector, in various examples. Display device 98 may also include or be part of a specialized interface for ARCA system 100 as shown in any of FIGS. 1-4.

Input/output unit 92 may include a drive, socket, or outlet for receiving computer program product 70, which includes a computer-readable medium 72 having computer program code 74 stored thereon. For example, computer program product 70 may be a CD-ROM, a DVD-ROM, a Blu-Ray disc, a magnetic disc, a USB stick, a flash drive, or an external hard disc drive, as illustrative examples, or any other suitable data storage technology. Input/output unit 92 may also include or be part of a specialized interface for ARCA system 100 as shown in FIGS. 1-4.

Computer-readable medium 72 may include any type of optical, magnetic, or other physical medium that physically encodes program code 74 as a binary series of different physical states in each unit of memory that, when read by computing device 80, induces a physical signal that is read by processor 84 that corresponds to the physical states of the basic data storage elements of storage medium 72, and that induces corresponding changes in the physical state of processor unit 84. That physical program code signal may be modeled or conceptualized as computer-readable instructions at any of various levels of abstraction, such as a high-level programming language, assembly language, or machine language, but ultimately constitutes a series of physical electrical and/or magnetic interactions that physically induce a change in the physical state of processor unit 84, thereby physically causing or configuring processor unit 84 to generate physical outputs that correspond to the computer-executable instructions, in a way that causes computing device 80 to physically assume new capabilities that it did not have until its physical state was changed by loading the executable instructions comprised in program code 74.

In some illustrative examples, program code 74 may be downloaded over a network to data storage device 96 from another device or computer system for use within computing device 80. Program code 74 including computer-executable instructions may be communicated or transferred to computing device 80 from computer-readable medium 72 through a hard-line or wireless communications link to communications unit 90 and/or through a connection to input/output unit 92. Computer-readable medium 72 comprising program code 74 may be located at a separate or remote location from computing device 80, and may be located anywhere, including at any remote geographical location anywhere in the world, and may relay program code 74 to computing device 80 over any type of one or more communication links, such as the Internet and/or other packet data networks. The program code 74 may be transmitted over a wireless Internet connection, or over a shorter-range direct wireless connection such as wireless LAN, Bluetooth™, Wi-Fi™, or an infrared connection, for example. Any other wireless or remote communication protocol may also be used in other implementations.

The communications link and/or the connection may include wired and/or wireless connections in various illustrative examples, and program code 74 may be transmitted from a source computer-readable medium 72 over mediums, such as communications links or wireless transmissions containing the program code 74. Program code 74 may be more or less temporarily or durably stored on any number of intermediate physical computer-readable devices and mediums, such as any number of physical buffers, caches, main memory, or data storage components of servers, gateways, network nodes, mobility management entities, or other network assets, en route from its original source medium to computing device 80.

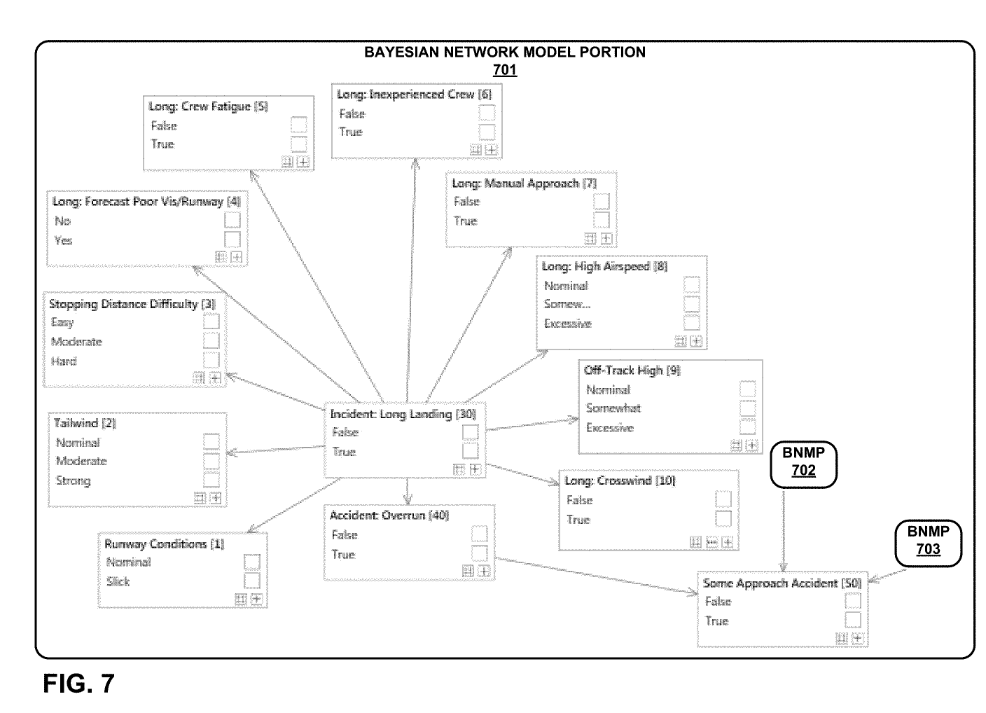

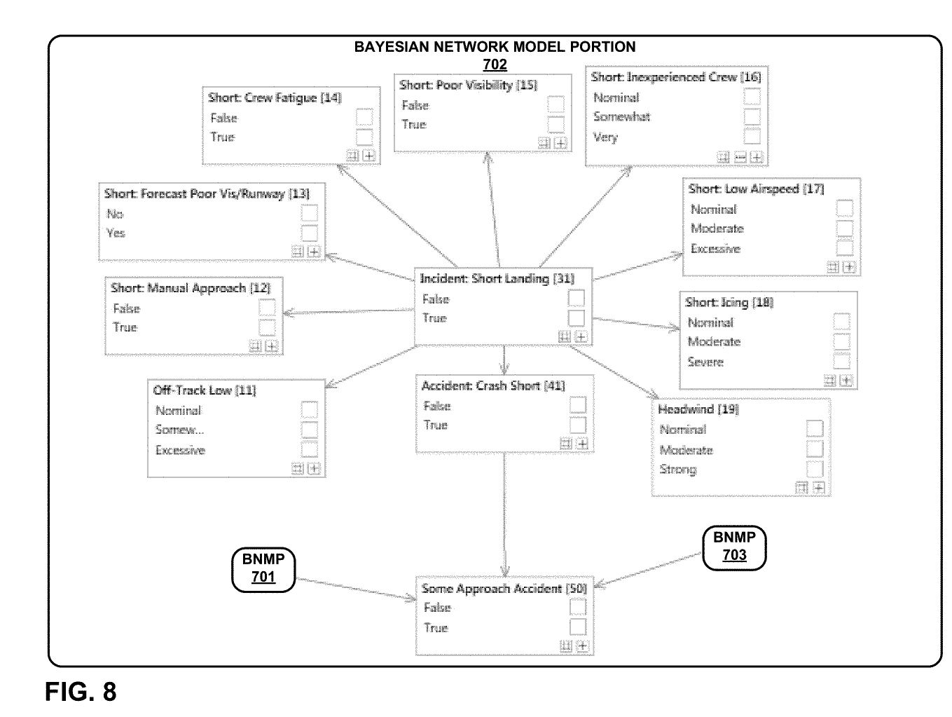

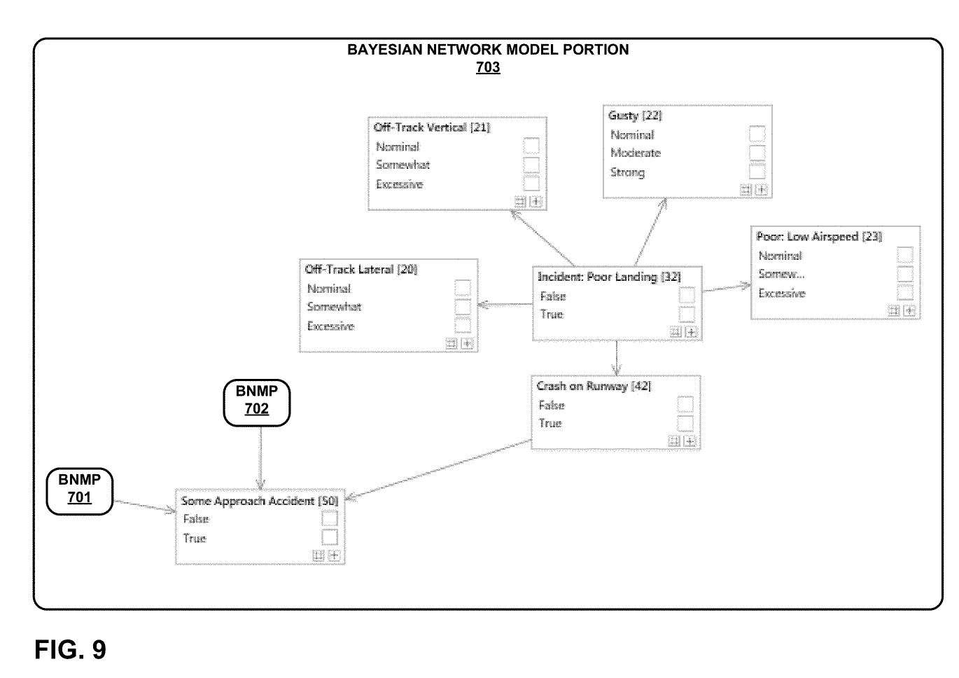

FIGS. 7-9 depict another example of a Bayesian network model that ARCA system 100 may use to perform risk analysis associated with various available clearance options and/or to determine recommendations from among one or more available operations for a given clearance. FIGS. 7-9 depict different portions of an example Bayesian network model, divided for legibility between three different, overlapping Bayesian network model portions 701, 702, and 703 depicted in FIGS. 7-9, respectively, addressing risks associated with runway overrun accidents, crashes short of the runway, and crashes on the runway, respectively. As shown in FIGS. 7-9, various risk factors may be evaluated for a Boolean true or false condition or for conditions with more than two possible states, and each risk factor has an associated variable indicative of that factor's strength in a conditional probability distribution.

In one or more examples, the functions described herein may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processing units (e.g., processors) to retrieve instructions, code and/or data structures for implementation of the techniques described in this disclosure. A computer program product may include a computer-readable medium.

By way of example, and not limitation, such computer-readable storage media can comprise random access memory (RAM), read-only memory (ROM), electrically erasable programmable read-only memory (EEPROM), compact disc read-only memory (CD-ROM) or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processing units (e.g., processors), such as one or more digital signal processors (DSPs), general purpose microprocessors, application specific integrated circuits (ASICs), field programmable logic arrays (FPGAs), or other equivalent integrated or discrete logic circuitry. Accordingly, the term “processing unit” or “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processing units as described above, in conjunction with suitable software and/or firmware.

Depending on the embodiment, certain acts or events of any of the methods described herein can be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processing units, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples are described above and depicted in the figures. These and other examples are within the scope of the following claims.

What is claimed is:

1. A method comprising:
receiving, by a computing device comprising one or more processors and from a plurality of sources, data associated with an aircraft that is in an operation, wherein the plurality of sources comprises one or more sources of historical data and one or more sources of real-time data that is generated while the aircraft is in the operation;
performing, by the computing device, a risk analysis of the data using a Bayesian network model that models risks associated with the aircraft in the operation; and
generating, by the computing device, an output based at least in part on the risk analysis.

2. The method of claim 1, wherein generating the output comprises generating the output while the aircraft is preparing for or in the operation, wherein the operation comprises one or more of flight planning, gate preparation, pushback and taxiing at a departure location, takeoff, flight, arrival, approach, landing, and taxiing at an arrival location.

3. The method of claim 1,
wherein the Bayesian network model comprises a network of nodes connected by directed links,
wherein the nodes comprise relevant factor nodes that model relevant factors, precursor nodes that model precursors, incident nodes that model incidents, and accident nodes that model accidents, and
wherein the directed links comprise directed links between the relevant factor nodes and the precursor nodes, directed links between the precursor nodes and the incident nodes, and directed links between the incident nodes and the accident nodes.

4. The method of claim 3, further comprising:
receiving additional data;
comparing the additional data with outcomes modeled by the Bayesian network model; and
performing Bayesian updating of conditional probability distributions associated with the directed links based on results of comparing the additional data with the outcomes modeled by the Bayesian network model.

5. The method of claim 1, further comprising repeatedly performing the risk analysis while the aircraft is being operated in flight in the operation.

6. The method of claim 1, further comprising performing the risk analysis after receiving a flight plan for the operation and before the aircraft has received a takeoff clearance, wherein generating the output comprises generating an output comprising one or more identified risk factors associated with one or more available takeoff clearances.

7. The method of claim 1, further comprising performing the risk analysis after the aircraft has received a takeoff clearance or a departure clearance, wherein generating the output comprises generating an output comprising one or more identified risk factors associated with the received takeoff clearance or the received departure clearance.

8. The method of claim 1, further comprising performing the risk analysis after receiving a flight plan for the operation and before the aircraft has received an arrival clearance, an approach clearance, or a landing clearance, wherein generating the output comprises generating an output comprising at least one of one or more recommended arrivals, one or more recommended approaches, or one or more recommended landings, or one or more identified risk factors associated with one or more available arrivals, one or more available approaches, or one or more available landings.

9. The method of claim 1, further comprising performing the risk analysis after the aircraft has received an arrival clearance, an approach clearance, or a landing clearance, wherein generating the output comprises generating an output comprising one or more identified levels of risk associated with the received arrival clearance, the received approach clearance, or the received landing clearance.

10. The method of claim 1, further comprising performing the risk analysis after the aircraft has received an approach clearance, wherein generating the output comprises generating an output comprising a risk alert associated with the clearance.

11. The method of claim 1, further comprising generating one or more reports summarizing sets of risk analyses for a plurality of flights or adding additional data to a store of generated data available to be used to modify the Bayesian network model.

12. The method of claim 1, further comprising communicating the output to at least one of the aircraft, an interface for a fleet operator of the aircraft, an air traffic control (ATC) authority, or an air navigation service provider (ANSP).

13. The method of claim 1, wherein the sources of real-time data comprise two or more of aircraft surveillance data, aircraft flight plan data for the aircraft, current crew status data for the aircraft, current System Wide Information Management (SWIM) data and/or other operations data, weather data from any type of weather data source, or real-time infrastructure data.

14. The method of claim 1, wherein the sources of historical data comprise data on past aircraft operations, past airport operations, past procedures, terrain, infrastructure, aircraft type, aircraft status, past clearances and associated outcomes, crew training and credentials, crew country of origin, or a number of years of experience a flight crew member has in performing their current functions.

15. A computing device comprising:
one or more processors; and
a computer-readable storage device communicatively coupled to the one or more processors, wherein the computer-readable storage device stores instructions that, when executed by the one or more processors, cause the one or more processors to:
receive, from a plurality of sources, data associated with an aircraft that is in an operation, wherein the plurality of sources comprises one or more sources of historical data and one or more sources of real-time data that is generated while the aircraft is in the operation;
perform a risk analysis of the data using a Bayesian network model that models risks associated with the aircraft in the operation; and
generate an output based at least in part on the risk analysis.

16. The computing device of claim 15,
wherein the Bayesian network model comprises a network of nodes connected by directed links,
wherein the nodes comprise: relevant factor nodes that model relevant factors, precursor nodes that model precursors, incident nodes that model incidents, and accident nodes that model accidents,
wherein the directed links comprise: directed links between the relevant factor nodes and the precursor nodes, directed links between the precursor nodes and the incident nodes, and directed links between the incident nodes and the accident nodes, and
wherein the instructions further cause the one or more processors to:
receive additional data;
compare the additional data with outcomes modeled by the Bayesian network model; and
perform a Bayesian updating of conditional probability distributions associated with the directed links based on results of comparing the additional data with outcomes modeled by the Bayesian network model.

17. The computing device of claim 15, wherein the instructions further cause the one or more processors to perform the risk analysis such that performing the risk analysis comprises at least one of:
performing the risk analysis before the aircraft has received a clearance, wherein generating the output comprises generating an output comprising at least one of one or more recommended clearances or one or more identified risk factors associated with one or more available clearances;
performing the risk analysis after the aircraft has received a clearance, wherein generating the output comprises generating an output comprising a risk alert associated with the clearance; or
performing the risk analysis after the aircraft has landed, wherein generating the output comprises one or more of generating one or more reports summarizing sets of risk analyses for a plurality of flights or adding additional data to a store of generated data available to be used to modify the Bayesian network model.

18. A computer-readable data storage device storing instructions that, when executed, cause a computing device comprising one or more processors to perform operations comprising:
receiving, from a plurality of sources, data associated with an aircraft that is in an operation, wherein the plurality of sources comprises one or more sources of historical data and one or more sources of real-time data that is generated while the aircraft is in the operation;
performing a risk analysis of the data using a Bayesian network model that models risks associated with the aircraft in the operation; and
generating an output based at least in part on the risk analysis.

19. The computer-readable data storage device of claim 18,
wherein the Bayesian network model comprises a network of nodes connected by directed links,
wherein the nodes comprise: relevant factor nodes that model relevant factors, precursor nodes that model precursors, incident nodes that model incidents, and accident nodes that model accidents,
wherein the directed links comprise: directed links between the relevant factor nodes and the precursor nodes, directed links between the precursor nodes and the incident nodes, and directed links between the incident nodes and the accident nodes, and
wherein the instructions further cause the computing device to perform operations comprising:
receiving additional data;
comparing the additional data with outcomes modeled by the Bayesian network model; and
performing a Bayesian updating of conditional probability distributions associated with the directed links based on results of comparing the additional data with outcomes modeled by the Bayesian network model.

20. The computer-readable data storage device of claim 18, wherein the instructions further cause the computing device to perform operations comprising at least one of:
performing the risk analysis before the aircraft has received a clearance, wherein generating the output comprises generating an output comprising at least one of one or more recommended clearances or one or more identified risk factors associated with one or more available clearances;
performing the risk analysis after the aircraft has received a clearance, wherein generating the output comprises generating an output comprising a risk alert associated with the clearance; or
performing the risk analysis after the aircraft has landed, wherein generating the output comprises one or more of generating one or more reports summarizing sets of risk analyses for a plurality of flights or adding additional data to a store of generated data available to be used to modify the Bayesian network model.
